(19) United States
(12) Patent Application Publication
(10) Pub. No.: US 2022/0408423 A1
(43) Pub. Date: Dec. 22, 2022

(54) METHODS FOR NETWORK ASSISTANCE FOR MEDIA SERVICES, CORE NETWORK NODE, WIRELESS DEVICES AND RADIO ACCESS NETWORK NODES

(71) Applicant: Sony Group Corporation, Tokyo (JP)

(72) Inventors: Rickard LJUNG, Helsingborg (SE); Lars NORD, Lund (SE); Svante ALNAS, Lund (SE); Paul SZUCS, Esslingen (DE)

(21) Appl. No.: 17/629,376

(22) PCT Filed: Sep. 30, 2020
(86) PCT No.: PCT/EP2020/077347

§ 371 Date: Jan. 22, 2022

(30) Foreign Application Priority Data
Oct. 18, 2019 (SE) 1951185-6

(51) Int. Cl. H04W 72/04

(52) U.S. Cl. CPC H04W 72/0406

(57) ABSTRACT

Disclosed is a method, performed by a core network node, for network assistance with a media service session for a wireless device. The core network node is configured to communicate with a radio access network, RAN, node. The method comprises receiving, from the RAN node, control signalling indicative of RAN information over a dedicated interface between the core network node and the RAN node; and controlling the network assistance for the media service session, based on the control signalling received.

The present disclosure pertains to the field of wireless communications. The present disclosure relates to methods, related core network nodes, related wireless devices, and related radio access network nodes.

### BACKGROUND

In a 3^{rd} Generation Partnership Project, 3GPP, system, a Network Assistance function enables a 3GP-DASH client to improve the quality of experience of content streaming sessions, and is provided by a DASH-aware network element, DANE, where DASH refers to Dynamic Adaptive Streaming over HTTP. For example, the DANE for this mode is out-of-band, i.e. it is not in the media delivery path. The Network Assistance communication is independent from the media server communication; hence the Network Assistance communication occurs in a separate path to the transfer of the media presentation description, MPD and the content segments. The media server does not need to be aware of the Network Assistance function.

Network Assistance may be made available to certain clients only, for example subject to subscription options or SLA (Service Level Agreement) between operator and media service provider. Client authentication may also be applied before granting access to Network Assistance service. Clients are able to discover the availability and information about the Network Assistance DANE, and to establish a Network Assistance session with the DANE.

Network Assistance is based on the model of the client requesting network assistance and the DANE responding to the request. The Network Assistance functionality may be granted to a client supporting the delivery of 3GP-DASH content with either only the first or with both of the two functions below, in both cases based on the 3GP-DASH client having made a request to the DANE for Network Assistance:
The DANE indicates to the 3GP-DASH client the highest suitable media rate for the next segment download, based on the available Representations for the content item;
The DANE indicates to the 3GP-DASH client a temporary delivery boost for occasions when the content playback input buffer on the client risks suffering from under-run. Such a boost may be temporary, and the 3GP-DASH client cannot assume such provision subsequently.

Once a Network Assistance session is active, the client may issue a Network Assistance call prior to fetching the next media segment from the media server. The Network Assistance call consists of a single Server and Network Assisted DASH (SAND) signaling exchange. This exchange with the DANE activates either the first of the above functions or a sequence of both functions; the second only if the 3GP-DASH client was granted access to the function. If the client does not need a delivery boost, then the DANE omits the second function in the response to the 3GP-DASH client.

### SUMMARY

In 5G Media Service, 5GMS, a client in the wireless device may perform 5G media streaming operations in relation to a data network, DN. Streaming operations may be enacted with a Media Application Function, AF, for control plane operations, and a Media Application server, AS, for user plane operations, e.g. to transport the media content and directly control its transport.

Currently, Network Assistance for 5GMS offers the facilities to the wireless device to e.g.:
1) recommend a media streaming bitrate from those offered by the wireless device as being the possible choices, and during a media streaming session, and
2) accept a request for RAN-layer temporary boost of media stream data transfer.

However, the current solutions for network assistance, based on DASH-container content delivered from the media server to the wireless device within the 3GPP PSS, Packet Switched Streaming, service are still not very flexible as regards both which services and which content that can be assisted. There is a need for supporting network assistance for uplink services, or for non-DASH content formats. There is a need for enhanced efficiency from refinement of the parameters used in the network assistance (e.g. Network Assisted Rate Adaptation, NARA, protocol), and for more flexibility and conformance with the 5G network architecture and procedures.

Accordingly, there is a need for core network nodes, wireless devices, and radio access network nodes and methods for network assistance for media services, which mitigate, alleviate or address the shortcomings existing and provides more flexibility to support network assistance (e.g. NARA) and to allow for improvements of network assistance (e.g. NARA) based on RAN performances.

Disclosed is a method, performed by a core network node, for network assistance with a media service session for a wireless device. The core network node is configured to communicate with a radio access network, RAN, node. The method comprises receiving, from the RAN node, control signalling indicative of RAN information over a dedicated interface between the core network node and the RAN node; and controlling the network assistance for the media service session, based on the control signalling received.

Further, a core network node is provided, the core network node comprising a memory circuitry, a processor circuitry, and an interface circuitry. The core network node is configured to perform any of the methods disclosed herein.

It is an advantage of the present disclosure that the method performed by the core network node, and the core network node disclosed provide improvements of network assistance (e.g. NARA) based on RAN performances, by receiving control signalling indicative of RAN information via the dedicated interface between the RAN node and CN node. For example, using a dedicated interface between the core network node and the RAN node decreases latency of communications needed for network assistance, e.g. in comparison with alternative methods such as communicating via other CN nodes. Also, the core network node disclosed provides the function of network assistance (e.g. NARA) based on actual RAN performance.

Further, disclosed is a method, performed by a wireless device, for network assistance for a media service session, wherein the wireless device is configured to communicate with a core network node. The method comprises communicating control signalling indicative of the network assistance for the media service session over a logical interface between the wireless device and the core network node using a session layer protocol.

Further, a wireless device is provided, the wireless device comprising a memory circuitry, a processor circuitry, and a wireless interface circuitry. The wireless device is configured to perform any of the methods disclosed herein.

It is an advantage of the present disclosure that the disclosed wireless device benefits from more flexibility to support network assistance (e.g. NARA) for a wider range of use cases, e.g. uplink media communications, gaming, video production or other multimedia centric services in addition to downlink communications by use of a session layer protocol over the logical interface between the wireless device and the core network node.

Disclosed is a method, performed by a radio access network node, for network assistance for media services, wherein the radio access network, RAN, node is configured to communicate with a core network node. The method comprises transmitting, to the core network node, control signalling indicative of RAN information over a dedicated interface between the core network node and the RAN node.

Disclosed is a radio access network node comprising a memory circuitry, a processor circuitry, and an interface circuitry, wherein the radio access network node is configured to perform any of the methods disclosed herein.

It is an advantage of the present disclosure that the disclosed RAN node is capable of providing a RAN information service to the CN node and to other CN nodes. Also, the RAN node disclosed herein supports the network assistance function and an enhancement of network assistance (such as NARA) in exploiting RAN information which indicates RAN performance or condition, so that for example rate adaptation can be improved. The present disclosure also allows the RAN node to remain stateless with respect to network assistance sessions that are being operated by the core network node.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1A is a diagram illustrating an exemplary 3GPP communication system according to this disclosure,

FIG. 1B is a diagram illustrating an example top-level architecture for a 5G media services within an example 5G system architecture,

FIG. 1C shows a schematic diagram of example interfaces according to this disclosure,

FIG. 1D a diagram illustrating an example top-level architecture for a 5G media services within an example 5G system architecture, including example interfaces disclosed herein,

FIG. 1E a diagram illustrating an example 5G downlink media service architecture with an example media session handler in the wireless device or UE,

FIG. 2 is a flow-chart illustrating an exemplary method, performed at a CN node, for network assistance according to this disclosure,

FIG. 3 is a flow-chart illustrating an exemplary method, performed at a wireless device, for network assistance according to this disclosure,

FIG. 4 is a flow-chart illustrating an exemplary method, performed at a RAN node, for network assistance according to this disclosure,

FIG. 5 is a block diagram illustrating an exemplary CN node according to this disclosure,

FIG. 6 is a block diagram illustrating an exemplary wireless device according to this disclosure,

FIG. 7 is a block diagram illustrating an exemplary RAN node according to this disclosure, and

FIGS. 8A-D are signalling diagrams according to this disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

When using certain applications/services such as media streaming, there is a benefit for the network to:

Be able to recommend the preferred or most suitable bitrate for the transfer of media data, and be aware of transient problems with the transmission that cause the need to boost the transmission intermittently.

Also, the wireless device (e.g. including a client) can benefit from receiving network information in order to adapt functionality and parameters within the wireless device (e.g. the wireless device client).

On a general level, the present disclosure provides a functionality for how to integrate and improve (and possibly implement) network assistance into a 5G network architecture.

However, based on the current technology there is e.g. a further need for supporting network assistance for uplink services, or for non-DASH content formats. There is also a need for enhanced efficiency from refinement of the parameters used in the network assistance (e.g. Network Assisted Rate Adaptation, NARA, protocol), and for more flexibility and conformance with the 5G network architecture.

It may be appreciated that the disclosed technique may be seen as a new over-arching protocol signaling between a wireless device, a core network node (e.g. an Application Function) and a radio access network, RAN, node, e.g. via two different signaling flows, where the signaling is communicated over multiple individual links. The disclosed signaling technique may enable a wireless device (e.g. a client in the wireless device) to interact with the RAN and the core network node to perform network assistance signaling. The disclosed overarching protocol functionality may be seen as signaling that is transferred over multiple nodes, where each of the nodes involved communicate information independently of how the different interfaces involved are defined. In some embodiments, the nodes in-between may not be involved in the transfer of the overarching protocol signaling.

It may be appreciated that there are communication protocols defined for the inter-node communication. We denote here a link as one such node-to-node communication protocol. In this disclosure, for example, each node is configured via the overarching communication to communicate information for network assistance independently of how the different interfaces are defined. In some embodiments, the nodes in-between may not be involved in the transfer of the overarching protocol signaling.

It may be appreciated that the disclosed technique may be seen as providing a definition of or embodiments related to the NARA function in the 5G media services architecture, for both downlink and uplink media streaming, consisting of two stages of the protocol, reflecting a mapping to the 5G system architecture.

The disclosed technique may be seen as providing a definition of or embodiments related to how the NARA function is invoked by the wireless device, e.g. by the media streaming client, media player, media application, or similar entity running on the wireless device.

The disclosed technique may be seen as providing a definition of or embodiments related to the NARA protocol over a logical interface between the wireless device and the core network node, (e.g. a Network Assistance Server, NAssS, e.g. in the AF), using a session layer protocol (e.g. HTTP, optionally using a RESTful API over HTTP).

The disclosed technique may be seen as providing a definition of or embodiments related to the dedicated interface (e.g. the NARA as a Common API Framework, CAPIF, instantiation) used by the core network node, (e.g. a Network Assistance Server, NAssS, e.g. in the AF) to communicate with the RAN node.

The disclosed technique may be seen as providing a definition of or embodiments related to how the core network node, (e.g. a Network Assistance Server, NAssS, e.g.

in the AF) executes NARA operations by way of interpreting control signaling (e.g. control messages) used in the NARA protocol and received over the logical interface from the wireless device and by formulating control signaling (e.g. appropriate control messaging) using the dedicated interface (e.g. a NARA CAPIF definition in the network interface to the RAN node) to the RAN node.

It may be appreciated that NARA may be a function that is available generally to wireless devices independently of any vertical service, e.g. a service that runs on top of SEAL (Service Enabler Architecture Layer for Verticals), specified in 3GPP TS 26.434. Embodiments herein of NARA may apply principally to devices and services that involve the reception (downlink) and/or transmission (uplink) of one or more media streams between the wireless device and the core network node (e.g. AF).

The disclosed technique advantageously provides control signaling and interfaces that are capable of supporting NARA for uplink communications as well. In other words, the disclosed control signalling and interfaces are added into a protocol which is generic and can be applied to other services than downlink video streaming (contrary to legacy, which includes network assistance for DASH-container media and applicable to downlink adaptive streaming only).

The figures are schematic and simplified for clarity, and they merely show details which aid understanding the disclosure, while other details have been left out. Throughout, the same reference numerals are used for identical or corresponding parts.

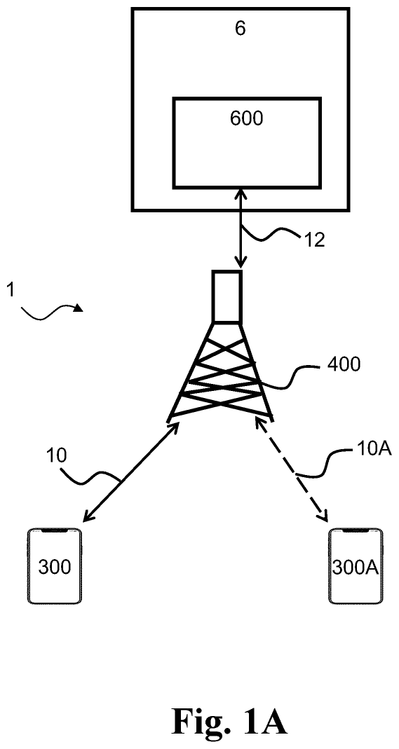

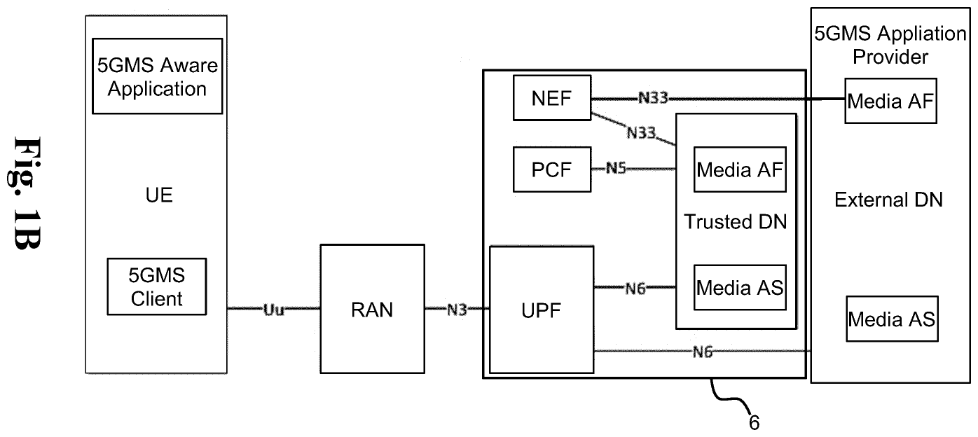

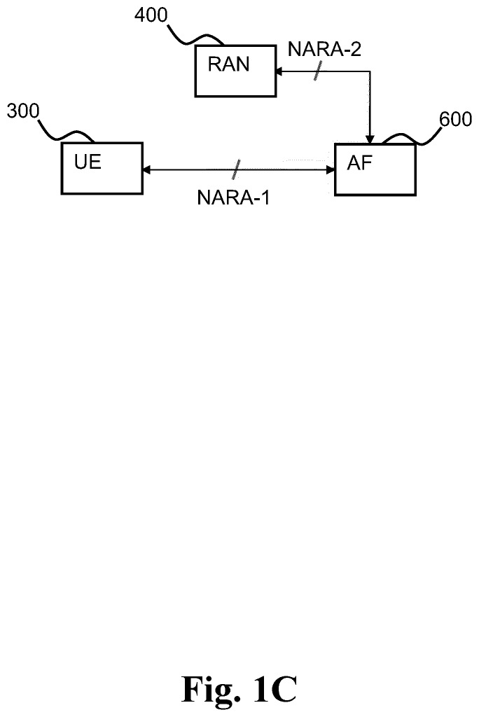

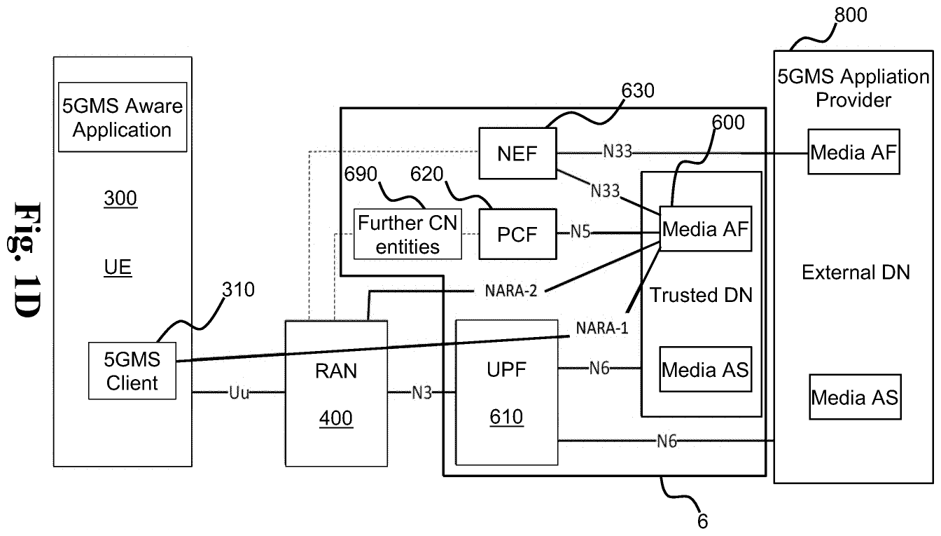

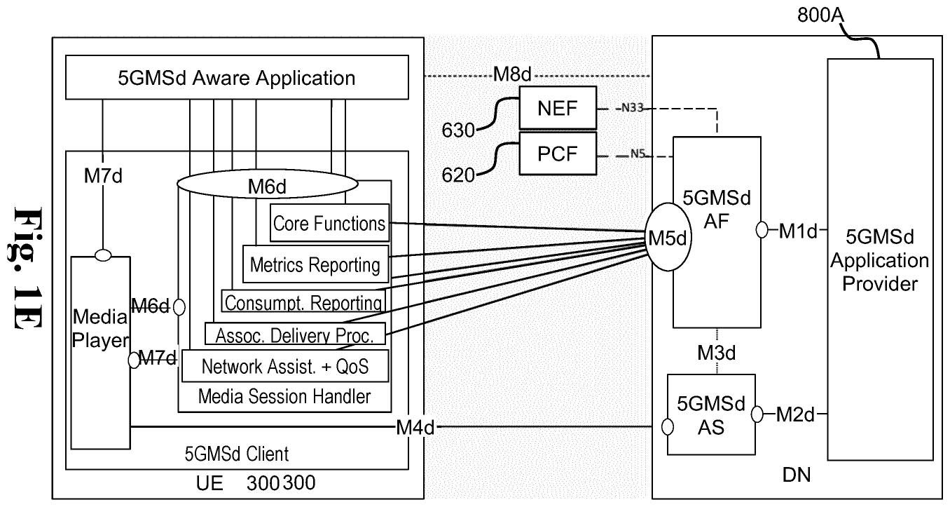

FIG. 1A is a diagram illustrating an exemplary wireless communication system 1 comprising an exemplary radio access network node 400 and an exemplary wireless device 300 according to this disclosure.

As discussed in detail herein, the present disclosure relates to a wireless communication system 1 comprising a cellular system, e.g. a 3GPP wireless communication system. The wireless communication system 1 comprises a wireless device 300. In some embodiments, the wireless communication system 1 comprises a RAN node 400. In some embodiments, the wireless communication system 1 comprises a core network node 600.

The core network node 600 may form part of a core network 6.

A RAN node disclosed herein refers to a radio access network node operating in a radio access network of the wireless communication system 1, such as a base station, an evolved Node B, eNB, gNB, and/or a radio access network controller.

The wireless communication system 1 described herein may comprise one or more wireless devices 300, 300A, and/or one or more RAN nodes 400, and/or one or more core network, CN, nodes 600.

A wireless device may e.g. refer to a mobile device and/or a user equipment, UE.

The wireless device 300, 300A may be configured to communicate with the RAN node 400 via a wireless link (or radio access link) 10, 10A.

The RAN node 400 may be configured to communicate with the CN node 600 via a communications link 12.

FIG. 1B is a diagram illustrating an example top-level architecture for a 5G media services within an example 5G system architecture. FIG. 1B shows an example top-level architecture of 5GMS and its relation to an overall 5G system architecture. FIG. 1B shows a wireless device 300 (e.g. UE 300) including a 5GMS client and 5GMS aware application. FIG. 1B shows a RAN node 400 configured to communicate with wireless device 300 over interface Uu. The RAN node 400 is configured to communicated with entities of the core network 6, such as an user plane function, UPF over N3 interface. The UPF is configured to communicate over N6 interface with the trusted Data Network, DN including a media AF 600 and a media AS, and with a 5GMS application provider 800, part of an external DN, including an external media AF and media AS. The media AF 600 is configured to communicated with a Network Exposure Function, NEF 630, over an N33 interface. The NEF is configured to communicated with the media AF of 800 over an interface N33. The media AF 600 is configured to communicated with a Policy Control Function 620, PCF, over an N5 interface.

In FIG. 1B, a client in the wireless device 300 performs 5G media streaming operations, uplink and/or downlink, to and/or from the data network, DN (or potentially both). Streaming operations are enacted with a Media Application Function, AF, for control plane operations, and a Media Application server, AS, for user plane operations, e.g. to transport the media content and directly control its transport.

Network Assistance for 5GMS offers the facilities to the wireless device to e.g.:
1) recommend a media streaming bitrate from those offered by the wireless device as being the possible choices, and during a media streaming session, and/or
2) accept a request for RAN-layer temporary boost of media stream data transfer.

However, solutions in existing 3GPP specifications are limited to Downlink, DL, communication. Indeed, the solutions in existing 3GPP specifications are applicable only to DASH-container content delivered from a media server to the wireless device, which is limited to downlink, within the 3GPP PSS, Packet Switched Streaming, service.

There is a need for supporting network assistance for uplink services, or for non-DASH content formats. There is a need for enhanced efficiency from refinement of the parameters used in the Network Assisted Rate Adaptation, NARA, protocol, and for more flexibility and to be conformant with the 5G network architecture and procedures.

FIG. 1C shows a schematic diagram of example interfaces according to this disclosure. FIG. 1C shows an example dedicated interface NARA-2 between an example CN node and an example RAN node disclosed. FIG. 1C shows an example logical interface

NARA-1 between an example CN node and an example wireless device. FIG. 1C shows an example dedicated interface NARA-2 between the CN node 600 (AF) and the RAN node 400. The example dedicated interface may be seen as network interface between the CN node 600 (AF) and the RAN node 400.

The disclosed technique proposes to form an over-arching signaling protocol for network assistance signaling involving the wireless device 300 (e.g. UE), a RAN node 400 (e.g. RAN in FIG. 1C) and CN node 600 (e.g. AF in FIG. 1C) to be carried out over multiple individual protocols (e.g. NARA-1 and NARA-2 of FIG. 1C) so as to enable direct logical connections over these individual protocols.

The interface NARA-1 is between the wireless device 300 and the CN node 600, such as an AF. The interface NARA-1 can be seen as a direct logical connection between the wireless device 300 and the CN node 600 over a signaling protocol that may be referred to as NARA-1 protocol.

In other words, the present technique involves two stages of a network assistance protocol (e.g. NARA) in order to be able to signal the network assistance functionality over the architecture defined in 3GPP. In the 5GMS, the wireless device 300 communicates with the CN node 600, e.g. AF, located in the core network, via the RAN node 400. The RAN node 400 of FIG. 1C may be configured to perform control functions over the communication channel. The RAN node may be configured to carry one or more media streams to which network assistance or NARA applies, between the wireless device 300 and the CN node 600 (AF).

The present disclosure provides a network assistance (e.g. NARA) architecture which comprises one or more of the two new interfaces illustrated in FIG. 1C between various entities in the 3GPP network and media services architecture.

FIG. 1D a diagram illustrating an example top-level architecture for a 5G media services within an example 5G system architecture, including example interfaces disclosed herein.

FIG. 1D shows an example logical interface, NARA-1, between a wireless device 300 and a CN node 600 (AF) according to some embodiments of this disclosure. The interface NARA-1 may be configured to carry out a network assistance protocol (e.g. NARA-1 protocol), which operates over the Uu, N3 and N6 interfaces, between the wireless device 300 and the CN node 600 (Media AF), which may be a trusted CN node (e.g. trusted AF as defined in the 3GPP system). A trusted CN node is a CN node which is part of a core network 6 of a network provider system (e.g. a 5G provider system). The wireless device 300 may comprise a 5GMS client 310, which may be in hardware and/or software.

FIG. 1D shows an example dedicated interface, NARA-2, between a RAN node 400 and a CN node 600 (AF) according to some embodiments of this disclosure. The interface NARA-2 may be configured to carry out a network assistance protocol (e.g. a NARA-2 protocol), which operates over a direct dedicated interface between the CN node 600 (Media AF) and the RAN node 400 (e.g. a radio access network controller). Stated differently, the dedicated interface referred as NARA-2 in FIG. 1D is according to the present disclosure used to make a direct connection between the AF and the RAN.

Dotted lines in FIG. 1D represent potential alternative methods to realize the NARA-2 protocol, by making use of the established functional entities and interfaces defined in the 3GPP system. It may be seen that they are, however, resulting in the increased latency of communications that is inherent with those methods. In particular the entities NEF 630, PCF 620 and further CN entities 690 are usually centralized, making the needed fast communication with the RAN unfeasible. The new interface between the Trusted AF and RAN enables the fast communication need for NARA-2.

The dedicated interface disclosed herein between the RAN node 400 and the CN node 600, so called NARA-2 in FIG. 1D, may be standardized or embodied for example as a proprietary and non-standardized protocol.

For example, the dedicated interface, NARA-2, and protocol may not need to necessarily depend on any 5G core network entities or interfaces, since it may be advantageous not to carry RAN status information inside the core network. Hence, the present disclosure proposes the dedicated interface, NARA-2, as a short-cut interface to implement NARA-2, going directly from the CN node 600 acting as a Trusted Media AF to the RAN node 400, without taking the usual intermediate route via the PCF 620, or NEF 630, and further CN entities 690 (e.g. AMF) in the 5G core network architecture. For example, the dedicated interface, NARA-2, may in some embodiments be a new Service Based Interface (SBI) where the CN node 600 (Trusted Media AF) can request to get notified based on subscribing to certain events or one-time request. The present disclosure enables the RAN node 400 to provide such a RAN information service to the CN node 600 acting as Trusted Media AF (or any authorized network node).

For example, when the NARA operation is associated with an application and streaming session, then a Bandwidth Management Service can be used be the AF or other entity to influence the bandwidth of the session, by increasing it, either temporarily or indefinitely.

The disclosed NARA function over the logical interface (illustrated as NARA-1 in FIG. 1D) can work between the wireless device and the CN node (AF), independently of any potential additional enhancement that includes communications with the AS and/or 5GMS Application Provider 800.

Optionally, Multimedia Priority Services (MPS), as defined by 3GPP, is also applicable for services that could also use NARA. The wireless device can have a subscription to MPS (See 3GPP TS 23.501 version 5.16.5). MPS is applicable only within the Mobile Network Operator, MNO, network. Onward links to e.g. production centers may be presumed to be wired and thus support guaranteed QoS.

The CN node 600 (e.g. Media AF) may be a Trusted AF, as defined in the 3GPP

System, since this enables easier access to the certain network interfaces and enable more efficient network assistance (e.g. NARA) execution.

The Media AS can be at a different physical location in the DN or even at an external location. It may be advantageous that the Media AF, which controls the media streams, and which hosts the NAssS, is a Trusted AF.

In some embodiments, a NARA-2 interface may be realized as shown as the dotted line from the PCF 620 to the RAN 400, via the “further CN entities” 690, or via interface N33 to the NED 630 and RAN 400. The further entities 690 are the SMF and Access and Mobility Management Function, AMF, as specified in TS 23.501. For example, in some embodiments, only the AMF has direct access to the RAN, and it is via the NG-AP protocol specified in TS 38.413 V15.5.0. It may be envisaged that this chain of interaction needs to be followed for a Media AF to communicate with the RAN in order to request adjustments with the handling of data transfer to or from a particular UE, meaning management of policy for a particular QoS Flow.

The logical interface disclosed herein between the wireless device 300 and the CN node 600, so called NARA-1 in FIG. 1D, may be embodied for example as a protocol using HTTP message exchanges which advantageously follow the principles of a

RESTful protocol, between the wireless device 300 and the CN node as AF 600.

For example, the wireless device 300 can use the logical interface NARA-1 and protocol to locate the CN node 600, such the NAssS in the AF, to initiate a network assistance session with the CN node 600 (NAssS), to request bitrate recommendations and boost requests as necessary during a media stream transfer session, then terminate the network assistance session when no longer required.

FIG. 1E a diagram illustrating an example 5G downlink media service architecture with an example media session handler in the wireless device or UE.

The original mechanism for NARA, containing the functions bitrate recommendation and boost request, was implemented using MPEG-SAND (Server and Network Assisted DASH) messaging and adopted in 3GPP specification TS 26.247 in Release 15. This does not support UL Network assistance.

FIG. 1E shows an interface M1d which is the interface for any NARA communications with the 5GMS app provider 800A. The inventors have discovered that there is no need for NARA to use Mid, since one of the core aspects of NARA is that it operates independently of the media service provider. The media service and server delivering the media stream, or entity receiving the media stream, do not need to be aware of NARA operating in the network at all. The same holds for interface M3d for NARA functions. M7d shown in FIG. 1E is the UE-internal system interface comprised in the wireless device or UE 300 for controlling the Media Player (MP). M7d can be invoked by both the app and the Media Session Handler (MSH). M6d includes the UE-internal application interface for controlling NARA and QoS control.

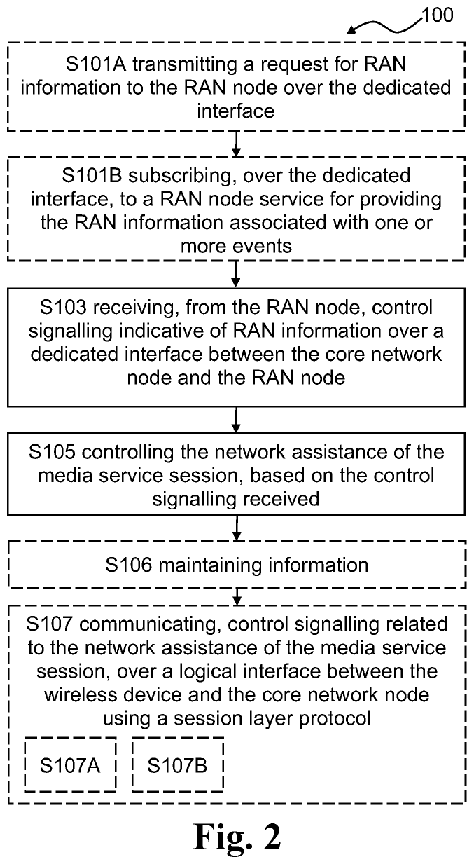

FIG. 2 shows a flow diagram of an exemplary method performed by a core network node (e.g. a core network node disclosed herein, such as core network node 600 of FIGS. 1A,1C, 1D, 5 and 8A-D), for network assistance with a media service session for a wireless device according to the disclosure. The core network node is configured to communicate with a radio access network, RAN, node. For example, the core network node is configured to act as an application function of the core network, e.g. a trusted application function (e.g. part of the network of the network provider).

The method 100 comprises receiving S103, from the RAN node, control signalling indicative of RAN information over a dedicated interface between the core network node and the RAN node. In one or more example methods, the method comprises transmitting S101A a request for RAN information to the RAN node, optionally over the dedicated interface. In one or more embodiments, the control signalling indicative of the RAN information is received over the dedicated interface in response to the request in S101A. In one or more example methods, the method comprises subscribing S101B, over the dedicated interface, to a RAN node service for providing the RAN information associated with one or more events (such as event-based signalling). In one or more embodiments, the control signalling indicative of the RAN information is received over the dedicated interface in response to occurrence of at least one of the one or more events, and the RAN information may be associated with the at least one event. For example, the CN node (AF) can request to get notified based on subscribing to certain events and/or based on a one-time request. An event may be seen as a network event, such as in the RAN.

The dedicated interface may be seen as a network interface and/or a logical interface that is configured to run between the RAN node and the CN node. For example, the dedicated interface is a direct interface. In one or more example methods, the dedicated interface comprises a service-based interface, SBI, between the core network node and the RAN node. The dedicated interface can be seen as a CAPIF interface. For example, the CN node (e.g. NARA AF) can uses the SBI to request temporary prioritization and/or a higher QoS level for the QoS flow for which the boost was requested with the RAN node from the wireless device. The RAN node may respond with either acceptance or rejection of the request. The CN node may respond to the wireless device correspondingly using the NA Boost Response.

The method comprises controlling S105 the network assistance for the media service session, based on the control signalling received. The network assistance procedure (e.g. control signalling session for network assistance) may take place over a network assistance session. The media service session is separate from the network assistance session. In other words, the network assistance session may be seen as a session that is separate, and/or dedicated, and/or detached from the media service session. In other words, the media service session may be seen as a separate, and/or dedicated, and/or detached media service session from the network assistance session. The network assistance may be performed by a NARA protocol. For example, the CN node (e.g. NARA AF) selects the recommended bitrate accordingly from those offered by the wireless device in the preceding recommendation request, for example, when the method of the logical interface (e.g. NARA-1) is used. For other NARA-1 methods for bitrate recommendation, the recommended bitrate is communicated back to the UE. It may be appreciated that the disclosed technique allows a simplification of the protocol in several aspects: an improved statelessness in the CN node (e.g. Media AF); a possible inclusion of both uplink and downlink network assistance in the combined function; and additional methods to request a bitrate recommendation (e.g. a method consisting of a simple request without any added information about the available bitrates, and a new method making the request and adding a single item of information to inform about the characteristics of the streaming session). The RAN information may be seen as RAN performance information.

In one or more example methods, the RAN information is indicative of one or more of: RAN performance, a RAN performance criterion, RAN performance criteria, and an activity parameter of the wireless device. RAN performance (e.g. RAN performance criteria) may comprise (e.g. be based on) channel performance, RAN condition, cell condition, channel quality condition, cell load condition, and/or a bandwidth condition. For example, when the NARA operation is associated with an application and streaming session, then a Bandwidth Management Service can be used be the AF or other entity to influence the bandwidth of the session, by increasing it, either temporarily or indefinitely. The RAN performance may relate to an expected maximum bitrate and/or throughput to DL or from UL. The activity parameter may be based on information about the UE's expected activity, such as in terms of state changes, and mobility. The activity parameter can apply in the PDU session context, and/or in the QoS Flow context.

In one or more example methods, the method 100 comprises maintaining S106 information about network assistance session, wherein the information comprises one or more of: a wireless device identifier of the wireless device and/or a session identifier of the media service session and/or a Quality-of-Service, QoS, flow identifier of the media service session. It may be appreciated that the RAN node does not need to be stateful as regards the wireless device or the data flow for which network assistance or NARA is being invoked. This may lead to the RAN node not needing to maintain any state associated with the network assistance session.

The dedicated interface is accessed by the core network node (e.g. Media AF) in order to perform network assistance or NARA functions with the RAN node. The dedicated interface can be mapped to an existing or new physical or logical interface between the core network node (AF) and the RAN node. The wireless device identifier may refer to a unique identifier enabling a unique identification of the wireless device making the network assistance or NARA request. The QoS flow identifier may refer to a unique identifier enabling a unique identification of the QoS flow used in the media service session (such as the data flow). The session identifier may refer to a unique identifier enabling a unique identification of network assistance session. The QoS flow identifier may be used to identify the media service session, e.g. PDU session. The information may comprise a direction of data flow, such as downlink (network to UE) and/or uplink (UE to network). In some embodiments, the wireless device identifier is needed only for the boost request, optionally with the QoS flow identifier.

The method according to any of the previous claims, the method 100 comprises communicating S107, control signalling related to the network assistance for the media service session, over a logical interface between the wireless device and the core network node using a session layer protocol. For example, communicating S107 the control signalling related to (or indicative of) the network assistance, over the logical interface comprises receiving and/or transmitting S107 the control signalling indicative of the network assistance, over the logical interface between the wireless device and the core network node using a session layer protocol. The session layer protocol may refer to a protocol running on the session layer, such as HTTP.

In one or more example methods, communicating S107 the control signalling related to the network assistance, NA, over the logical interface comprises receiving S107A, from the wireless device, a rate recommendation request (such as .g. bit rate recommendation(s)) and/or a boost request for temporary rate enhancement, e.g. during the media service session but over the NA session. For example, the wireless device provides the set of bitrates available and the CN node chooses one of them, or alternatively the wireless device requests a recommendation and the CN node returns the maximum recommended bitrate then the wireless device chooses the suitable version based on the recommendation.

In one or more example methods, communicating S107 the control signalling related to the network assistance, over the logical interface comprises establishing S107B a network assistance session with the wireless device. For example, establishing S107B the network assistance session comprises receiving an initiating request for the network assistance session and sending an initiation response. For example, establishing S107B the network assistance session comprises receiving a session initiation request comprising a session type indicative of UL and/or DL. A session type parameter can be “downlink” or “uplink”, signifying the direction of transfer of the corresponding media stream. The session type parameter may be a stateful parameter belonging to the session.

In some embodiments, two separate NARA protocols dedicated to downlink and to uplink respectively. For example, the following implementation may be carried out:

| Resource | | HTTP | |
|---|---|---|---|
| name | Resource URI | method | Meaning |
| Initiate | /session/{type} | POST | Request to create a |
| NARA | | | new NARA session |
| session | | | |
| Terminate | /session/{Id} | DELETE | Delete an existing |
| NARA | | | NARA session |
| Session | | | |
| Bitrate | /session/{Id}/bitrateRe- | POST | Request a bitrate |
| Recommen- | commendation/ | PATCH | recommendation, |
| dation | {availableBitrates} | UPDATE | with the provision |
| | | | of the “available |
| | | | bitrates” resource |
| Bitrate | /session/{Id}/bitrateRe- | POST | Request a maxi- |
| Recommen- | commendation | | mum bitrate |
| dation | | | recommendation |
| Delivery | /session/{Id}/deliv- | POST | Request a |
| Boost | eryBoost | | “delivery boost” |
| | [symbol] Time period? | | resource |

In some embodiments, a generic network assistance session for the UE may be established, which allows one or more stream instantiations, where each stream can be downlink (e.g. 00) or uplink (e.g. 01).

In some embodiments, the wireless device may supply available bitrates and the CN node selects the best one. For example, the UE asks for recommendation, e.g.

maximum reasonable continuous streaming bitrate, without any info about which bitrates are available. For example, the UE asks for recommendation, and informs about QoS level (e.g. 5QI) that has been granted or that is expected for the streaming session—this has the advantage that the CN node gets to know roughly what the UE expects. The QoS level may be agreed between the AF and the Network via NEF. The

AF can also be notified whether the QoS can no longer be fulfilled by the network. Many streaming scenarios may be best effort QoS, and this may be an interesting case for NARA when not having any guaranteed bitrate from the network. In some embodiments, the logical interface (e.g. NARA-1 protocol) QoS negotiation function. For example, a NARA protocol can be defined in terms of a REST/HTTP protocol, using JSON (JavaScript Object Notation) or YAML (Yet Another Markup Language, also known as YAML Ain′t Markup Language) as formats to define the contents of NARA protocol exchanges. For example, NARA protocol may be in the form of: POST {apiRoot}/3gpp-5gms-nara/v1/InitialiseSession. For example, a version of HTTP can be used, as supported by the UE and AF. For example, NARA API calls use HTTP POST, GET etc. as appropriate for the method in question. OpenAPI/Swagger may be used for API definitions in 5GMS. JSON and YAML may be example embodiments.

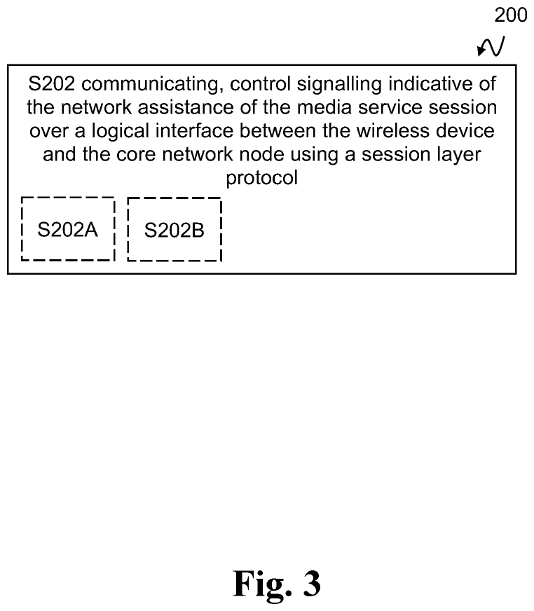

FIG. 3 shows a flow diagram of an exemplary method 200 performed by a wireless device, for network assistance with a media service session for the wireless device, according to the disclosure. The wireless device is configured to communicate with a core network node (and with a RAN node). The method 200 comprises communicating S202, control signalling indicative of the network assistance for the media service session over a logical interface between the wireless device and the core network node using a session layer protocol. The session layer protocol may refer to a protocol running on the session layer, such as HTTP. The network assistance procedure may take place over a network assistance session. The media service session is separate from the network assistance session (e.g. control signalling session for network assistance).). In other words, the network assistance session may be seen as a separate, and/or dedicated, and/or detached session from the media service session. In other words, the media service session may be seen as a separate, and/or dedicated, and/or detached media service session. Compared to network assistance using the MPEG-SAND messaging framework, the need to allocate an IP port number for NARA communications between NAssS and UE is removed. No

NARA protocol port number is needed, since HTTP is used as transport for protocol exchanges.

In one or more example methods, the control signalling is indicative of a session type of the media service session, wherein the session type is indicative of an uplink, UL, session and/or a downlink, DL, session. In one or more example methods, the control signalling is between the wireless device and the core network node dedicated to an uplink media session and/or a downlink media session. For example, the CN node may a CN node dedicated to uplink media session and/or a downlink media session, such as NAsS dedicated to uplink media session and/or a downlink media session

In one or more example methods, communicating S202 the control signalling indicative of the network assistance, over the logical interface comprises transmitting 5202A, to the core network node, a rate recommendation request (e.g. bit rate recommendation(s)) and/or a boost request for temporary rate enhancement.

In one or more example methods, communicating S202 the control signalling indicative of the network assistance, over the logical interface comprises establishing 5202B a network assistance session with the core network node (as also illustrated in S107B of FIG. 2). For example, establishing 5202B the network assistance session comprises initiating the network assistance session and receiving initiation response. For example, establishing 5202B the network assistance session comprises transmitting a session initiation request comprising a session type indicative of UL and/or DL.

In one or more example methods, the logical interface comprises an application programming interface, API (e.g. a stateful API, e.g. a RESTful API, where REST denotes Representational State Transfer). For example, a network assistance feature can be invoked in the wireless device either by the embedded Media Player (MP) function, or by an Application running on the wireless device, or by the Application running on the wireless device that invokes network assistance (e.g. NARA) via the MP function. For example, the MSH handles NARA autonomously.

In one or more example methods, the method 200 comprising establishing a network assistance session with the core network node without using an IP address and/or port number of the core network node. It may be appreciated that the disclosed technique provides more efficient methods to reference the CN node (e.g. NAssS entity) in the core network, and the media streaming session to which the network assistance operation applies, rather than adopting the approaches used in release 15 NARA (IP address, port number). In other words, the need to allocate an IP port number for NARA communications between NAssS and UE is removed. No NARA protocol port number is needed, since HTTP is used as transport for protocol exchanges.

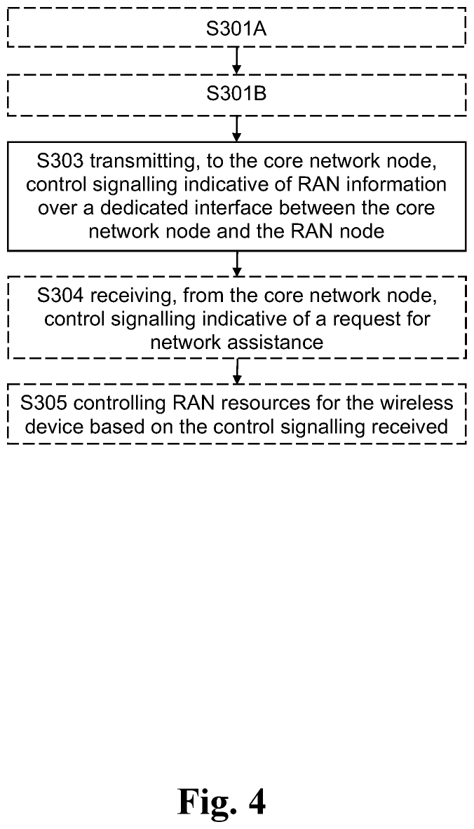

FIG. 4 shows a flow diagram of an exemplary method performed by a radio access network node, for network assistance with a media service session, according to the disclosure. The radio access network, RAN, node is configured to communicate with a core network node.

The method comprises transmitting S303, to the core network node, control signalling indicative of RAN information over a dedicated interface between the core network node and the RAN node. For example, the RAN information is received by the network node in S103 of FIG. 2. In one or more example methods, the RAN information is indicative of one or more of: a RAN performance, and an activity parameter of the wireless device. In one or more example methods, the dedicated interface comprises a service-based interface between the core network node and the RAN node. This allows the RAN node to remain stateless as regards to the network assistance session(s) that the core network node (e.g. AF) is managing. It may be appreciated that the RAN node is capable of providing a RAN information service to the CN node and to other CN nodes. Also, the RAN node disclosed herein supports an enhancement of network assistance (such as NARA) in exploiting RAN information which indicates RAN performance or condition.

In one or more example methods, the method comprises receiving S304, from the core network node, control signalling indicative of a request for network assistance for the media service session.

In one or more example methods, the method comprises controlling S305 RAN resources for the wireless device based on the control signalling received.

In one or more example methods, the method comprises receiving S301A a request for RAN information from the core network node over the dedicated interface.

In one or more example methods, the method comprises receiving S301B, from the core network node, over the dedicated interface, a subscription request to a RAN node service for providing the RAN information associated with one or more events.

In some embodiments, the dedicated interface involves manipulation of the QoS policy of the relevant media streaming session. For example, in a first approach, the CN node (e.g. NAssS AF) carries out adjustments of QoS policy or temporary boost via the N5 interface with the PCF. QoS control can be performed at one of 3 levels: Service data flow; QoS flow (ARP (Allocation and Retention Priority) value and 5QI (5G QoS Identifier)) with a QoS Flow ID (QFI) which can be assigned dynamically or set to the QFI; PDU (Protocol Data Unit) session which can contain several QoS flows. In some embodiments, RFSP(RAT/Frequency Selection Priority) index may be changed intermittently (see 23.503 6.1.2.1).

In some embodiments, NARA applies also to MPS (Multimedia priority services) [TS 22.153], since also MPS can benefit from the source device providing an uplinked audiovisual stream obtaining guidance from the network on the most suitable bitrate to be used, and enabling the boost request mechanism, even when MPS has priority over other services that are in operation at the same time. However, this first approach may suffer from the need to communicate through several core network entities, thus likely making the processing of NARA operations too burdensome and will create latency (RAN-AMF-SMF-NEF-AF-UE instead of RAN-AF-UE) in the assistance information from RAN to the UE client.

For in a second approach, the AF hosting the NAssS accesses NARA functionality that is exposed by the NEF, via some NARA Service API, within interface N33 in the 3GPP system architecture (cf. TS 23.502 [3] Clause 5.2.6.9). However, this method also is seen as less efficient. This second approach may be realized as a so-called CAPIF northbound interface in the 5G network architecture. As stated in the 5G architecture (TS 23.501 clause 6.2.5.1), when a NEF is used for external exposure, provision network with preferred policies and onboarding of clients, the CAPIF may be supported. When CAPIF is supported, a NEF that is used for external exposure supports the CAPIF API provider domain functions. The CAPIF and associated API provider domain functions are specified in TS 23.222.

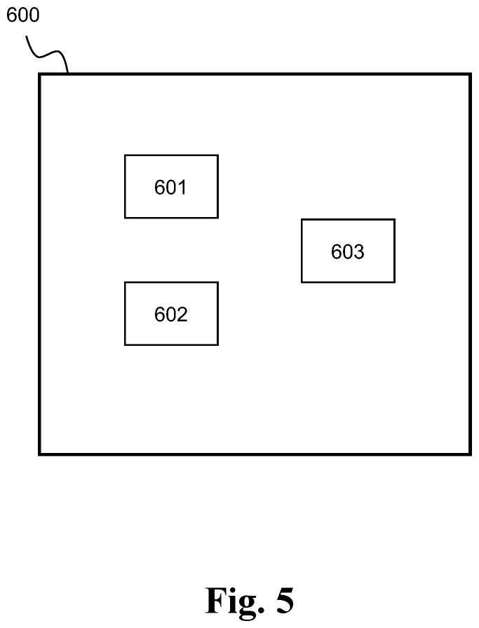

FIG. 5 shows a block diagram of an example core network node 600 according to the disclosure. The core network node 600 comprises a memory circuitry 601, a processor circuitry 602, and an interface circuitry 603. The core network node 600 may be configured to perform any of the methods disclosed in FIG. 2.

The core network node 600 is configured to communicate with a RAN node, such as the RAN node disclosed herein, and/or a wireless device, e.g. the wireless disclosed herein. The interface 603 may be configured for wired and/or wireless communications via a wireless communication system, such as a 3GPP system, such as a 3GPP system supporting network assistance.

The core network node 600 is configured to receive, e.g. via the interface circuitry 603, from the RAN node, control signalling indicative of RAN information over a dedicated interface between the core network node and the RAN node; and

The core network node 600 is configured to control, e.g. via the processor circuitry 602 the network assistance for the media service session, based on the control signalling received.

The processor circuitry 602 is optionally configured to perform any of the operations disclosed in FIG. 2 (any one or more of: S101A, S101B, S107, S107A, S107B). The operations of the core network node 600 may be embodied in the form of executable logic routines (e.g., lines of code, software programs, etc.) that are stored on a non-transitory computer readable medium (e.g., the memory circuitry 601) and are executed by the processor circuitry 602).

Furthermore, the operations of the wireless device 600 may be considered a method that the wireless circuitry is configured to carry out. Also, while the described functions and operations may be implemented in software, such functionality may as well be carried out via dedicated hardware or firmware, or some combination of hardware, firmware and/or software.

The memory circuitry 601 may be one or more of a buffer, a flash memory, a hard drive, a removable media, a volatile memory, a non-volatile memory, a random access memory (RAM), or other suitable device. In a typical arrangement, the memory circuitry 601 may include a non-volatile memory for long term data storage and a volatile memory that functions as system memory for the processor circuitry 602. The memory circuitry 601 may exchange data with the processor circuitry 602 over a data bus. Control lines and an address bus between the memory circuitry 601 and the processor circuitry 602 also may be present (not shown in FIG. 5). The memory circuitry 601 is considered a non-transitory computer readable medium.

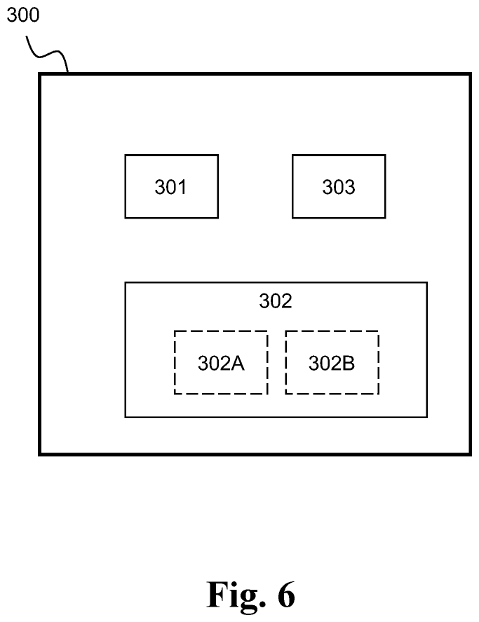

FIG. 6 shows a block diagram of an example wireless device 300 according to the disclosure. The wireless device 300 comprises a memory circuitry 301, a processor circuitry 302, and a wireless interface circuitry 303. The wireless device 300 may be configured to perform any of the methods disclosed in FIG. 3.

The wireless device 300 is configured to communicate with a RAN node, such as the RAN node disclosed herein, using a wireless communication system. The wireless interface 303 is configured for wireless communications via a wireless communication system, such as a 3GPP system, such as a 3GPP system supporting network assistance. The wireless device 300 is configured to communicate with a CN node, via the RAN node.

The wireless device 300 is configured to communicate, e.g. via the wireless interface circuitry 303, control signalling indicative of the network assistance for the media service session over a logical interface between the wireless device and the core network node using a session layer protocol (e.g. step S202 of FIG. 3).

The processor circuitry 302 is optionally configured to perform any of the operations disclosed in FIG. 3 (any one or more of:, 5202A, 5202B). The operations of the wireless device 300 may be embodied in the form of executable logic routines (e.g., lines of code, software programs, etc.) that are stored on a non-transitory computer readable medium (e.g., the memory circuitry 301) and are executed by the processor circuitry 302).

Furthermore, the operations of the wireless device 300 may be considered a method that the wireless circuitry is configured to carry out. Also, while the described functions and operations may be implemented in software, such functionality may as well be carried out via dedicated hardware or firmware, or some combination of hardware, firmware and/or software.

The memory circuitry 301 may be one or more of a buffer, a flash memory, a hard drive, a removable media, a volatile memory, a non-volatile memory, a random access memory (RAM), or other suitable device. In a typical arrangement, the memory circuitry 301 may include a non-volatile memory for long term data storage and a volatile memory that functions as system memory for the processor circuitry 302. The memory circuitry 301 may exchange data with the processor circuitry 302 over a data bus. Control lines and an address bus between the memory circuitry 301 and the processor circuitry 302 also may be present (not shown in FIG. 6). The memory circuitry 301 is considered a non-transitory computer readable medium.

The processor circuitry 302 may comprise a client circuitry 302A configured to perform client function(s) for network assistance, such as a NARA client function. The client circuitry 302A can be accessed by a 5GMS-aware application via the NARA API, which is a component of the M6d interface as depicted FIG. 1E.

The processor circuitry 302 may comprise a 5GMS client circuitry 302B.

There may be various modes for network assistance, such as NARA, to operate in the wireless device 300. For example, the wireless device 300 may operate autonomously from the media application, when the wireless device 300 is able to decide itself when it is necessary or desirable to perform network assistance procedures in order to either improve or maintain the quality of experience (QoE) of the media streaming session: the 5GMS client circuitry 302B may be configured to invoke the logical interface (e.g. NARA-1) and to manage its usage, either based on interaction with the Media Player entity, or with the UE middleware. This mode may be advantageous because the media application does not need to be aware of NARA-1 nor does it need to control it.

In some embodiment, when for example, the wireless device 300 may be configured to run a 5GMS-aware application that controls the network assistance procedure itself. For example, the application manages the invocation and usage of the logical interface (e.g. NARA-1), via interface M6d. This mode may be used for example when the application performs the selection of a particular representation of the content to either download or upload and manages rate adaptation based on the available representations of the media asset. The example modes are conformant with the 5G media services architecture model of the UE, depicted in FIG. 1E.

The wireless device 300 may comprise a Media Player configured to access M6d interface in order to invoke and use the NARA service, using the logical interface (e.g. NARA-1 interface and protocol), as well as other Media Session Handler services as appropriate. This can apply also when the wireless device 300 is not implemented according to the architecture disclosed herein, e.g. when there are no explicitly identified Media Player, MP, and Media Session Handler, MSH, functions that use the M6d and M7d interfaces for mutual control. For example, the network assistance can be invoked and managed by the wireless device middleware or functional entity that manages the reception or provision of media streams in the wireless device, without needing network assistance to be controlled by the application, which may be less efficient.

In some embodiments of the wireless device, the client circuitry 302A configured to perform client function(s) for network assistance may be confined within the 5GMS client circuitry 302B, since the 5GMS application may not need to be aware of details like media buffers in the media player and react upon boundary conditions to use network assistance. If this is so then it is still needed to enable MSH to know the media versions available to be up/downlinked for NARA bitrate recommendation.

The logical interface, NARA-1 and protocol, support is provided by the CN node, such as a Network Assistance Server (NAssS) function in an AF, located in the core network. For example, NARA, i.e. the NAssS function, could be one of several services provided by the AF, or alternatively, the NAssS constitutes an AF, so that NARA is the sole dedicated function of that AF.

The M5d interface of the wireless device 300 can implement several and various service interfaces. For example, NARA is one of these and it falls under the functionality “Network assistance and QoS”.

In the 5G network system architecture, logical interface, e.g. APIs, are identified by a URL-like structure. The general resource structure is for example:

{apiRoot}/{apiName}/{apiVersion}/{apiSpecificResourceUriPart}

The field apiRoot is not defined by 3GPP and is left for implementations to choose or discover. How this is done is outside the scope of the present disclosure.

The apiName field uniquely identifies the network assistance (NARA) service and interface over which the network assistance (NARA)protocol is executed. The apiName for network assistance (NARA) may be, for example, NetworkAssistance, nara, Nara, or NARA, or some other identifier to indicate that the network assistance (NARA)service, and NARA-1 interface or protocol is being used. The NARA-specific part of the string may be prefixed by a general label for the AF, e.g. “3_gpp_MediaAF_”.

he apiVersion field indicates the version of the protocol. For the present disclosure the version is for example set to “1” or some other value to indicate the first edition of the NARA-1 protocol definition.

The apiSpecificResourceUriPart represents the component of the NARA-1 protocol.

The legacy NARA function requires the media streaming server IP address and port number to be known/identified before session setup, which may require e.g. an address lookup function etc. to be implemented. This is not necessary in the present disclosure for network assistance (NARA)in the 5G network architecture.

For example, the wireless device 300 establishes a NARA session with the CN node, e.g. NAssS in the network, using the logical interface carrying out a NARA-1 protocol. When a NARA session is requested by the wireless device 300 and established by the NAssS; the wireless device 300 may be configured to maintain a private data structure exemplified by the set of data fields in the following structure for each QoS Flow within a media service session (e.g. DPU Session):
NA session identifier—reference for the NA session, allocated by the AF when an NA session is created. This can be a number or a string set by the NAssS in the Media AF.
The Identifier for the media streaming session is the QoS Flow, e.g. either delivering or providing the stream.
The wireless device (client 302B) can setup a PDU session to get an access to the DN and receive an IP address.
a QoS Flow with corresponding filters/policies will be setup (5-tuple, Source address and port, Destination address and port, protocol). The AS may be identified by the source address for DL stream, or the destination address for the UL stream.
Service data flow/QoS flow within PCC—policy and charging control.
Type of stream indicated within stream identifier, i.e. uplink or downlink. QoS

Flow. It is possible to have several QoS Flows within the same PDU session, e.g. there could be one for UL and another for DL.
Segment duration—nominal time period for a content segment over which an NA request is valid.
Available Bitrates-set of bitrate values available either to be consumed or provided by the UE.
Recommended Bitrate—the currently valid recommendation from among those available
NA Boost Request status-active or inactive.

The present disclosure allows for classification of network assistance session—for a media streaming session that is downlink to UE and/or uplink from UE. This has the benefit that both uplink and downlink delivery is covered using the same framework. A wireless device 300 that needs both downlink and uplink streams needs to run only a single network assistance session with the NAssS. Differentiation may be done within the protocol which anyway needs to differentiate between individual content streams.

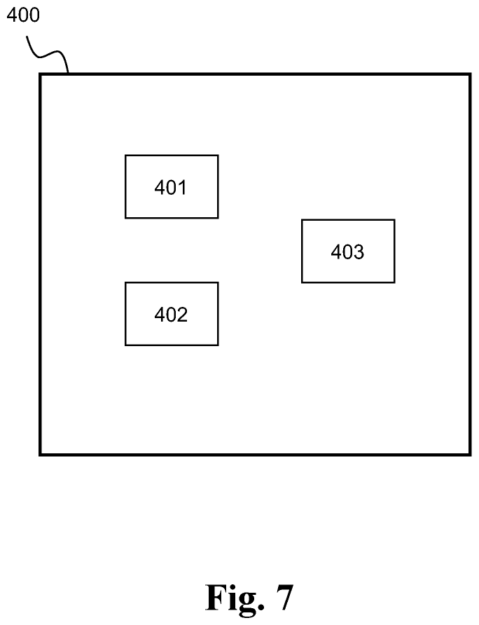

FIG. 7 shows a block diagram of an example radio access network node 400 according to the disclosure. The radio access network node 400 comprises a memory circuitry 401, a processor circuitry 402, and an interface circuitry 403. The radio access network node 400 may be configured to perform any of the methods disclosed in FIG. 4.

The radio access network node 400 is configured to communicate with a core network node, such as the core network node disclosed herein

The radio access network node 400 is configured to transmit, e.g. via the interface circuitry 403, to the core network node, control signalling indicative of RAN information over a dedicated interface between the core network node and the RAN node.

The processor circuitry 402 is optionally configured to perform any of the operations disclosed in FIG. 4 (any one or more of: S304, S305, S301A, S301B). The operations of the wireless device 400 may be embodied in the form of executable logic routines (e.g., lines of code, software programs, etc.) that are stored on a non-transitory computer readable medium (e.g., the memory circuitry 401) and are executed by the processor circuitry 402).

Furthermore, the operations of the wireless device 400 may be considered a method that the wireless circuitry is configured to carry out. Also, while the described functions and operations may be implemented in software, such functionality may as well be carried out via dedicated hardware or firmware, or some combination of hardware, firmware and/or software.

The memory circuitry 401 may be one or more of a buffer, a flash memory, a hard drive, a removable media, a volatile memory, a non-volatile memory, a random access memory (RAM), or other suitable device. In a typical arrangement, the memory circuitry 401 may include a non-volatile memory for long term data storage and a volatile memory that functions as system memory for the processor circuitry 402. The memory circuitry 401 may exchange data with the processor circuitry 402 over a data bus. Control lines and an address bus between the memory circuitry 401 and the processor circuitry 402 also may be present (not shown in FIG. 7). The memory circuitry 401 is considered a non-transitory computer readable medium.

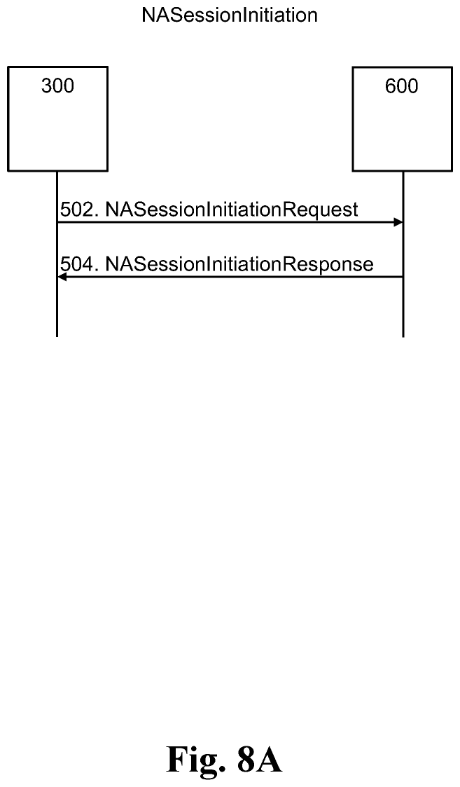

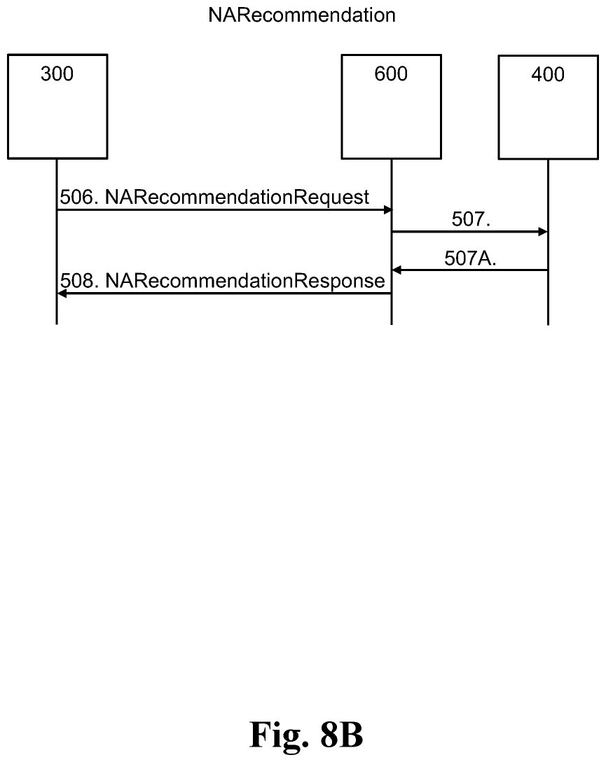

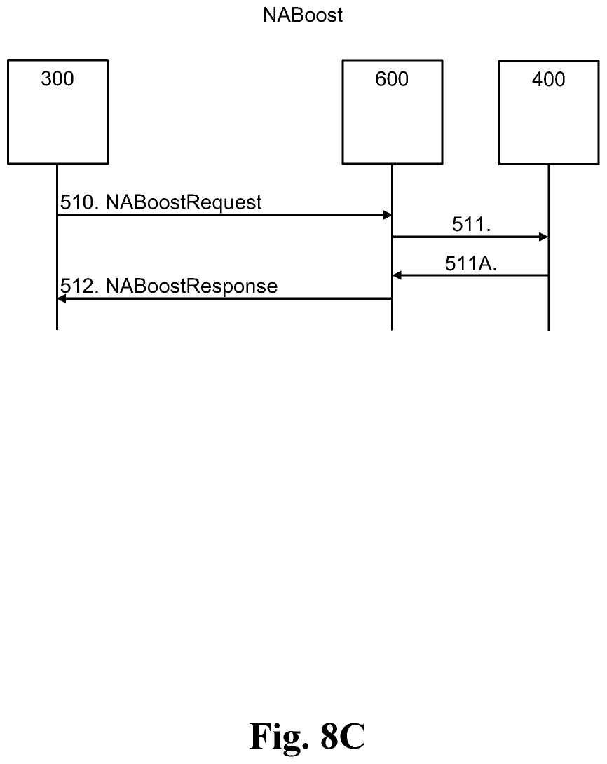

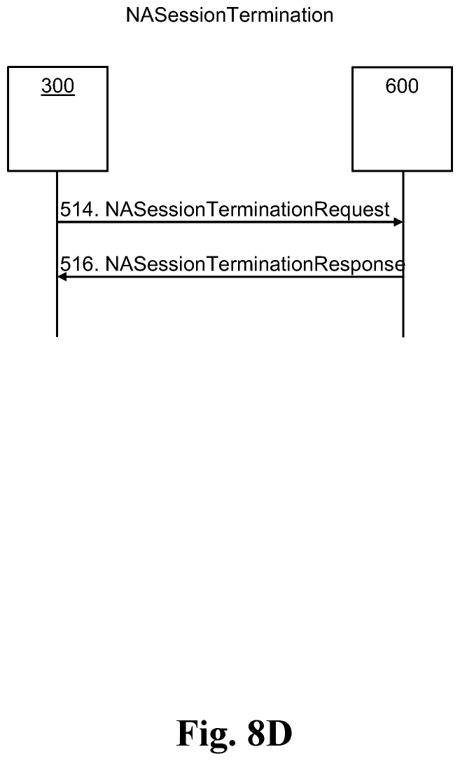

FIG. 8A-D are signalling diagrams according to this disclosure. FIG. 8A is a signalling diagram illustrating a network assistance session initiation between a wireless device 300 and a CN node 600. The wireless device 300 transmits over the disclosed logical interface a network assistance session initiation request 502 to initiate a network assistance session (e.g. a NARA session) and receives over the logical interface a network assistance session initiation response 504.

FIG. 8B is a signalling diagram illustrating a network assistance, NA recommendation procedure between a wireless device 300 and a CN node 600. The wireless device 300 transmits over the disclosed logical interface a NA recommendation request 506 to request e.g. rate recommendation. The CN node 600 transmits over the dedicated interface disclosed herein (e.g. SBI), an inquiry 507 to the RAN node 400, for example to enquire the expected maximum bitrate/throughput for (DL) or for (UL).

With the response 507A from the RAN node 400, the CN node 600 (e.g. NARA AF) selects the recommended bitrate accordingly from the bitrates offered by the UE in the preceding NA recommendation request 506, e.g. when the logical interface is used. The recommended bitrate may be communicated back to the wireless device 300 in a NA recommendation response 508. The wireless device 300 is then capable of choosing the most appropriate stream version/bitrate itself and starts media streaming.

The CN node 600 can communicate the recommended bitrate to the wireless device using the NA recommendation response 508.

FIG. 8C is a signalling diagram illustrating a network assistance, NA boost procedure between a wireless device 300 and a CN node 600. The wireless device 300 transmits over the disclosed logical interface a NA boost request 510 to request e.g. temporary prioritization or a higher QoS level for the QoS flow for which the boost was requested with the RAN node 300. The CN node 600 transmits over the dedicated interface disclosed herein (e.g. SBI), an inquiry 511 to the RAN node 400, for example to enquire the boost. The RAN node 400 responds 511A with either acceptance or rejection of the request. The CN node 600 responds to the wireless device 300 correspondingly using the NA Boost Response 512.

FIG. 8D is a signalling diagram illustrating a network assistance, NA boost procedure between a wireless device 300 and a CN node 600. The wireless device 300 transmits over the disclosed logical interface a NA session termination request 514 and receives a NA session termination response 516

Table 1 below shows how the signalling can affect state changes at the CN node and wireless device:

| Method | Type | Direction | Brief Description |
|---|---|---|---|
| NASessionInitia- | State change | UE → | Request to initiate a |
| tionRequest | | AF/NAssS | NARA session |
| NASessionInitia- | State change | AF/NAssS → | Response to NARA |
| tionResponse | | UE | session initiation request |
| NARecommen- | State change | UE → | Request a NARA bitrate |
| dationRequest | | AF/NAssS | recommendation |
| NARecommen- | State change | AF/NAssS → | Response to NARA |
| dationResponse | | UE | bitrate recommendation |
| | | | request |
| NABoostRequest | State change | UE → | Request a NARA boost |
| | | AF/NAssS | |
| NABoostResponse | Response | AF/NAssS → | Response to NARA |
| | | UE | boost request |
| NASessionTermin- | State change | UE → | Request to terminate a |
| ationRequest | | AF/NAssS | NARA session |
| NASessionTermin- | Response | AF/NAssS → | Response to NARA |
| ationResponse | | UE | session termination |
| | | | request |

Table 1 shows an example set of NARA operations in terms of whether a state change is implied by each message. With an HTTP embodiment of the NARA protocol, the request-response pair may be combined in a single HTTP transaction. The overall objective of a “RESTful” protocol is to eliminate the requirement for the server or the RAN node to be aware of client state.

With NARA, the necessary stateful aspect is the NARA session. This is beneficial so that the CN Node, e.g. NAssS, can establish and maintain a NARA session on behalf of the client (UE). Since NARA sessions might be granted only to UEs that fulfil certain requirements, it is advantageous to maintain sessions so that the right of a client UE to operate NARA does not have to be verified with every call of the NARA protocol.

Embodiments of methods and products (core network node, wireless device, radio access network node) according to the disclosure are set out in the following items:

Item 1. A method, performed by a core network node, for network assistance with a media service session for a wireless device, wherein the core network node is configured to communicate with a radio access network, RAN, node, the method comprising:
receiving (S103), from the RAN node, control signalling indicative of RAN information over a dedicated interface between the core network node and the RAN node; and
controlling (S105) the network assistance for the media service session, based on the control signalling received.

Item 2. The method according to item 1, wherein the method comprises transmitting (S101A) a request for RAN information to the RAN node over the dedicated interface.

ITEM 3. The method according to any of items 1-2, wherein the method comprises subscribing (S101B), over the dedicated interface, to a RAN node service for providing the RAN information associated with one or more events.

Item 4. The method according to any of items 1-3, wherein the RAN information is indicative of one or more of: RAN performance criteria, and an activity parameter of the wireless device.

Item 5. The method according to any of items 1-4, wherein the dedicated interface comprises a service-based interface between the core network node and the RAN node.

Item 6. The method according to any of items 1-5, wherein the method comprises maintaining (S106) information about network assistance session, wherein the information comprises one or more of: a wireless device identifier of the wireless device and/or a session identifier of the media service session and/or a Quality-of-Service, QoS, flow identifier of the media service session.

Item 7. The method according to any of items 1-6, the method comprising
communicating (S107), control signalling related to the network assistance for the media service session, over a logical interface between the wireless device and the core network node using a separate session layer protocol.

Item 8. The method according to item 7, wherein communicating (S107) the control signalling related to the network assistance for the media service session, over the logical interface comprises receiving (S107A), from the wireless device, a rate recommendation request and/or a boost request for temporary rate enhancement.

Item 9. The method according to any of items 7-8, wherein communicating (S107) the control signalling related to the network assistance, over the logical interface comprises establishing (S107B) a network assistance session with the wireless device.

Item 10. A method, performed by a wireless device, for network assistance for a media service session, wherein the wireless device is configured to communicate via a network with a core network node, the method comprising:
communicating (S202), control signalling indicative of a network assistance for the media service session over a logical interface between the wireless device and the core network node using a session layer protocol.

Item 11. The method according to item 10, wherein the control signalling is indicative of a session type of the media service session, wherein the session type is indicative of an uplink, UL, session and/or a downlink, DL, session.

Item 12. The method according to item 10 or 11, wherein the control signalling is between the wireless device (300) and a core network node (600) dedicated to an uplink media session and/or a core network node (600) dedicated to a downlink media session.

Item 13. The method according to any of items 10-12, wherein communicating (S202) the control signalling indicative of the network assistance for the media service session, over the logical interface comprises transmitting (5202A), to the core network node, a rate recommendation request to the core network node and/or a boost request for rate enhancing.

Item 14. The method according to any of items 10-13, wherein communicating (S202) the control signalling indicative of the network assistance for the media service session, over the logical interface comprises establishing (5202C) a network assistance session with the core network node.

Item 15. The method according to any of items 10-14, wherein the logical interface comprises an application programming interface.

Item 16. The method according to any of items 10-15, the method comprising establishing a network assistance session with the core network node without using an IP address and/or port number of the core network node.

Item 17. A method, performed by a radio access network node, for network assistance for media services, wherein the radio access network, RAN, node is configured to communicate via a network with a core network node and/or a wireless device, the method comprising:
transmitting (S303), to the core network node, control signalling indicative of RAN information over a dedicated interface between the core network node and the RAN node.

Item 18. The method according to item 17, wherein the method comprises:
receiving (S304), from the core network node, control signalling indicative of a request for network assistance for the media service session; and
controlling (S305) RAN resources for the media service session based on the control signalling received.

Item 19. The method according to any of items 17-18, wherein the method comprises receiving (S301A) a request for RAN information from the core network node over the dedicated interface.

Item 20. The method according to any of items 17-19, wherein the method comprises receiving (S301B), from the core network node, over the dedicated interface, a subscription request to a RAN node service for providing the RAN information associated with one or more events.

Item 21. The method according to any of items 17-20, wherein the RAN information is indicative of one or more of: a RAN performance, and an activity parameter of the wireless device.

Item 22. The method according to any of items 17-21, wherein the dedicated interface comprises a service-based interface between the core network node and the RAN node.

Item 23. A core network node comprising a memory circuitry, a processor circuitry, and an interface circuitry, wherein the core network node is configured to perform any of the methods according any of items 1-9.

Item 24 A wireless device comprising a memory circuitry, a processor circuitry, and a wireless interface circuitry, wherein the wireless device is configured to perform any of the methods according to any of items 10-16.

Item 25. A radio access network node comprising a memory circuitry, a processor circuitry, and an interface circuitry, wherein the radio access network node is configured to perform any of the methods according to any of items 17-22.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1A-8D comprises some circuitries or operations which are illustrated with a solid line and some circuitries or operations which are illustrated with a dashed line. The circuitries or operations which are comprised in a solid line are circuitries or operations which are comprised in the broadest example embodiment. The circuitries or operations which are comprised in a dashed line are example embodiments which may be comprised in, or a part of, or are further circuitries or operations which may be taken in addition to the circuitries or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly to be regarded in an illustrative rather than restrictive sense. The claimed disclosure is intended to cover all alternatives, modifications, and equivalents.

1. A method, performed by a core network node, for network assistance with a media service session for a wireless device, wherein the core network node-is configured to communicate with a radio access network, RAN, node, the method comprising:
receiving, from the RAN node, control signalling indicative of RAN information over a dedicated interface between the core network node and the RAN node; and
controlling the network assistance for the media service session, based on the control signalling received.

2. The method according to claim 1, wherein the method comprises transmitting-a request for RAN information to the RAN node over the dedicated interface.

3. The method according to claim 1, wherein the method comprises subscribing, over the dedicated interface, to a RAN node service for providing the RAN information associated with one or more events.

4. The method according to claim 1, wherein the RAN information is indicative of one or more of: RAN performance criteria, and an activity parameter of the wireless device.

5. The method according to claim 1, wherein the dedicated interface comprises a service-based interface between the core network node and the RAN node.

6. The method according to claim 1, wherein the method comprises maintaining information about a network assistance session, wherein the information comprises one or more of: a wireless device identifier of the wireless device and/or a session identifier of the media service session and/or a Quality- of-Service, QoS, flow identifier of the media service session.

7. The method according to claim 1, the method comprising
communicating, control signalling related to the network assistance for the media service session, over a logical interface between the wireless device and the core network node using a session layer protocol.

8. The method according to claim 7, wherein communicating the control signalling related to the network assistance for the media service session, over the logical interface comprises receiving, from the wireless device, a rate recommendation request and/or a boost request for temporary rate enhancement.

9. The method according to claim 7, wherein communicating the control signalling related to the network assistance, over the logical interface comprises establishing a network assistance session with the wireless device.

10. A method, performed by a wireless device, for network assistance for a media service session, wherein the wireless device is configured to communicate with a core network node, the method comprising:
communicating control signalling indicative of a network assistance for the media service session over a logical interface between the wireless device and the core network node using a session layer protocol.

11. The method according to claim 10, wherein the control signalling is indicative of a session type of the media service session, wherein the session type is indicative of an uplink, UL, session and/or a downlink, DL, session.

12. The method according to claim 10, wherein the control signalling is between the wireless device and a core network node dedicated to an uplink media session and/or a core network node dedicated to a downlink media session.

13. The method according to claim 10, wherein
communicating the control signalling indicative of the network assistance for the media service session, over the logical interface comprises transmitting, to the core network node, a rate recommendation request to the core network node and/or a boost request for rate enhancing.

14. The method according to claim 10, wherein
communicating the control signalling indicative of the network assistance for the media service session, over the logical interface comprises establishing a network assistance session with the core network node.

15. The method according to claim 10, wherein the logical interface comprises an application programming interface.

16. The method according to claim 10, the method comprising establishing a network assistance session with the core network node without using an IP address and/or port number of the core network node.

17. A method, performed by a radio access network node, for network assistance for media services, wherein the radio access network, RAN, node is configured to communicate with a core network node, the method comprising:
transmitting, to the core network node, control signalling indicative of RAN information over a dedicated interface between the core network node and the RAN node.

18. The method according to claim 17, wherein the method comprises:
receiving, from the core network node, control signalling indicative of a request for network assistance for the media service session; and
controlling RAN resources for the media service session based on the control signalling received.

19. The method according to claim 17, wherein the method comprises receiving, from the core network node, over the dedicated interface, a subscription request to a RAN node service for providing the RAN information associated with one or more events.

20. The method according to claim 17, wherein the RAN information is indicative of one or more of: RAN performance, and an activity parameter of the wireless device.
